(19) United States
(12) Patent Application Publication
(10) Pub. No.: US 2008/0017132 A1
(43) Pub. Date: Jan. 24, 2008

(54) System for repelling animals

(75) Inventors: Alan J. Merrifield, San Mateo, CA (US); Harold S. Gain, San Bruno, CA (US)

Correspondence Address: DAVID LEWIS, 1250 AVIATION AVE., SUITE 200B, SAN JOSE, CA, 95110, US

(73) Assignee: Urban Wildlife Management, Inc., Burlingame, CA (US)

(21) Appl. No.: 11/879,270

(22) Filed: Jul. 16, 2007

Related U.S. Application Data
(60) Provisional application No. 60/831,583, filed on Jul. 17, 2006.

(51) Int. Cl. A01K 15/04

(52) U.S. Cl. 119/719

(57) ABSTRACT

In an embodiment at least an animal repeller is provided. Each animal repeller is provided a flexible tubing that protrudes from the animal repeller. The flexible tubing flails when an animal is detected within a perimeter of coverage in which the presence of animals is unwanted.

### RELATED APPLICATIONS

This application claims priority benefit of U.S. Provisional Patent Application Ser. No. 60/831,583, entitled “System for Repelling Animals,” filed Jul. 17, 2006, by Alan J. Merrifield and Harold S. Gain, Jr., which is hereby incorporated herein by reference.

### FIELD

The specification generally relates to repelling animals.

### NOTICE OF COPYRIGHT

A portion or portions of the disclosure of this document contains content that is subject to protection by copyright. There is no objection by the copyright owner to the facsimile reproduction of the patent document and/or the patent disclosure as it is displayed in the records and files of the Patent and Trademark Office, however, the copyright owner reserves all protections otherwise afforded.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

At times for a variety for reasons it may desirable to keep animals out of certain areas or away from certain items. Lethal devices such as electric wiring, firearms or lethal traps are often employed in an attempt to keep animals away from, or out of, certain areas. However, harming the animals may be undesirable. The animals also may be kept out of an area by installing devices that physically prevent access to a property. Some examples of devices that limit or prevent access are nettings and screens. In addition, intruding animals may be caught in non-lethal traps and then removed from the populated area.

### BRIEF DESCRIPTION OF THE FIGURES

In the following drawings like reference numbers are used to refer to like elements. Although the following figures depict various examples of the invention, the invention is not limited to the examples depicted in the figures.

FIG. 1 shows a block diagram of an embodiment of an animal repelling system.

FIG. 2 shows a block diagram of an embodiment of an animal repeller used within the animal repelling system of FIG. 1.

FIG. 3 shows a block diagram of an embodiment of the internal components of animal repeller of FIG. 2.

FIG. 4 shows a block diagram of an embodiment of the animal repeller of FIG. 3 with sealant on its electrical connections.

FIG. 5 shows a block diagram of a top view of an embodiment of the animal repeller of FIG. 2.

FIG. 6 shows a block diagram of an embodiment of the control box of FIG. 1.

FIG. 7 shows an exploded diagram of an embodiment of a portion of the animal repeller of FIG. 3.

FIG. 8 shows a block diagram of an embodiment of a moisture filter.

FIG. 9 shows a block diagram of an embodiment of an animal repeller resembling a snake.

FIG. 10 shows a block diagram of an embodiment of animal repeller resembling a skunk.

FIG. 11 shows a block diagram of an embodiment of animal repeller resembling a frog.

FIG. 12 shows a block diagram of an embodiment of animal repeller resembling a lily pad.

FIG. 13 shows a diagram of an embodiment of an animal repelling system with an air tank.

FIG. 14 shows a diagram of an embodiment of a demo of an animal repelling system.

FIG. 15A shows a flowchart of an example of a method of making an animal repelling system.

FIG. 15B shows a flowchart of an example of a method of assembling the control box of FIG. 15A.

FIG. 15C shows a flowchart of an example of a method of assembling an animal repeller.

FIG. 16 shows a flowchart of an example of a method of using an animal repelling system.

### DETAILED DESCRIPTION

Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

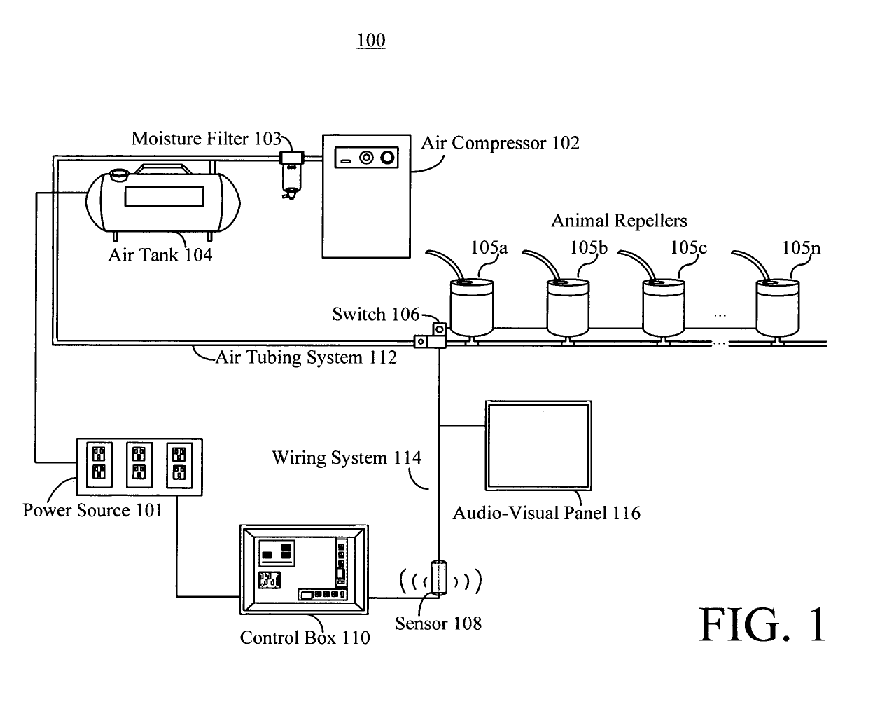

In general, at the beginning of the discussion of each of FIGS. 1-14 is a brief description of each element, which may have no more than the name of each of the elements in the particular figure that is being discussed. After the brief description of each element, each element of FIGS. 1-14 is further discussed in numerical order. In general, each of FIGS. 1-16 is discussed in numerical order, and the elements within FIGS. 1-16 are also usually discussed in numerical order to facilitate easily locating the discussion of a particular element. Nonetheless, there is not necessarily any one location where all of the information of any element of FIGS. 1-16 is located. Unique information about any particular element or any other aspect of any of FIGS. 1-16 may be found in, or implied by, any part of the specification.

FIG. 1 shows a diagram of an embodiment of an animal repelling system 100. Animal repelling system 100 includes power source 101, air compressor 102, moisture filter 103, air tank 104, animal repellers 105a-105n, switch 106, sensor 108, control box 110, air tubing system 112, wiring system 114, and audio-visual panel 116. In other embodiments, animal repelling system 100 may not have all of the components listed above or may have other components instead of and/or in addition to those listed above.

Animal repelling system 100 may repel animals from a location and thereby the negative affects that may be associated with the animal's presence. Power source 101 is a socket or receptacle (such as a wall outlet) that provides a voltage, frequency, and/or current that may power devices. Air compressor 102 may be any device that sends air through pipes. In an embodiment, air compressor 102 compresses air, which when released into a pipe, travels down the pipe. Air compressor 102 may send air to a set of one or more animal repellers. In an embodiment, air compressor 102 may be replaced with another device, such as a fan or turbine, that is capable of sending air through pipe.

In an embodiment, moisture filter 103 may limit moisture in the air released for compressor 102. Moisture filter 103 may prevent, or at least reduce, internal water damage to animal repelling system 100 (FIG. 1), as compared to the water damage that may occur without moisture filter 103.

Air tank 104 is optional and may be a pneumatic pressure vessel for storing the air pressurized by air compressor 102. Air tank 104 may have different storage capacity depending on the number of animal repellers in the animal repelling system 101 and/or depending on a desired length of usage.

Animal repellers 105a-105n may generate noise and/or motion that is expected to repel animals. In an embodiment, animal repellers 105a-105n may include flexible tubing that receives flowing air. The flowing air causes the flexible tubing of animal repellers 105a-105n to flail erratically and/or generate noise. In other embodiments, other devices may be used to generate the motion and/or noise instead of animal repellers 105a-105n.

Switch 106 optionally controls the state of a valve within animal repellers 105a-105n. The valve enables or disables the flow of air into animal repellers 105a-105n depending on whether the valve is open or closed. In an embodiment, switch 106 is optional, is activated by the motion and/or presence of an animal detected by an animal detector, and may be used in addition to or instead of placing switches within animal repellers 105a-105n. In an embodiment, switch 106 may be located external to animal repellers 105a-105n. In an embodiment, switch 106 controls several animal repellers 105a-105n.

Sensor 108 is a device for detecting the motion or presence of an animal. In an embodiment, sensor 108 may sense motion. In another embodiment, sensor 108 may sense heat, use radar, sonar, or a variety of other types of sensing devices. For example, sensor 108 may be a Range Controlled Radar (RCR) unit or an Infrared Emission (IRE) photoelectric sensor. In embodiments, sensor 108 may be a single device or a combination of devices working in unison to detect the presence or motion of an animal.

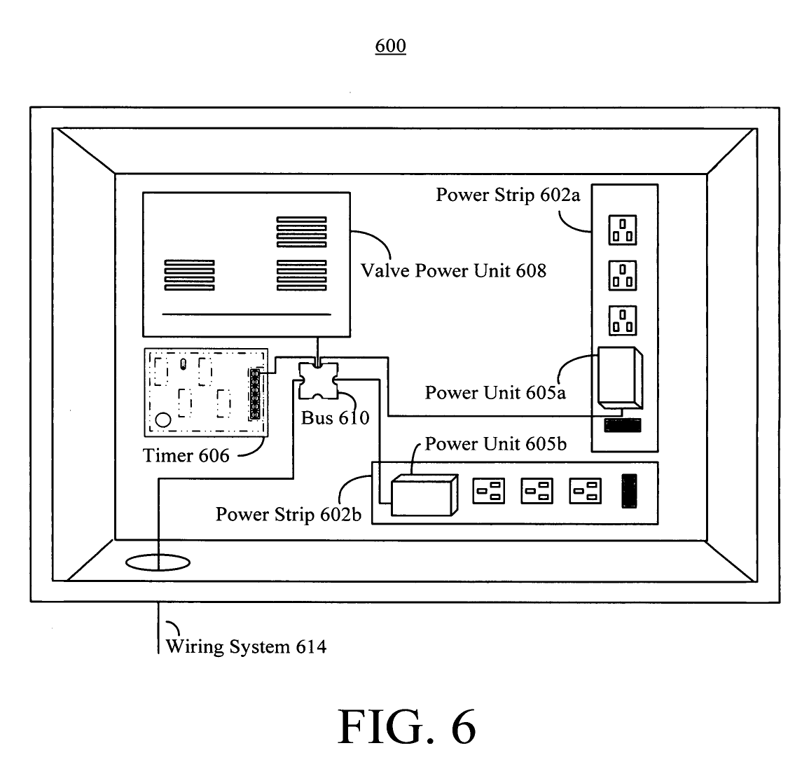

Control box 110 controls and/or powers the components of the animal repellers of animal repelling system 100. In an embodiment, control box 110 may power animal repellers 105a-105n and/or regulate the duration of time that animal repellers 105a-105n remain active after being activated. Control box 110 may include one or more power supply units and one or more timers (which will be discussed further in conjunction with FIG. 6).

Air tubing system 112 may carry air sent by air compressor 102 into animal repellers 105a-150n and from one of animal repellers 105a-105n to the next one of animal repellers 105a-105n. Air tubing 112 may connect animal repellers 105a-105n to one another. Wiring system 114 may carry electricity from power source 101 to components of animal repelling system 100. Wiring system 114 may carry electricity from control box 110 to animal repellers 105a-105n, switch 106, and sensor 108. Audio-visual panel 116 emits light and noise in response to sensor 108 sensing the presence of an animal, and sending a signal. Audio-visual panel 116 is optional and may be used together with, or instead of, animal repellers 105a-105n. If audio visual panel 116 is included together with animal repellers 105a-105n, each may complement the other. In an embodiment, audio-visual panel 116 may include a noise maker and strobe light. In other embodiments, audio-visual panel 116 may have other audio and/or visual components instead of, or in addition to, a noise maker and a strobe light.

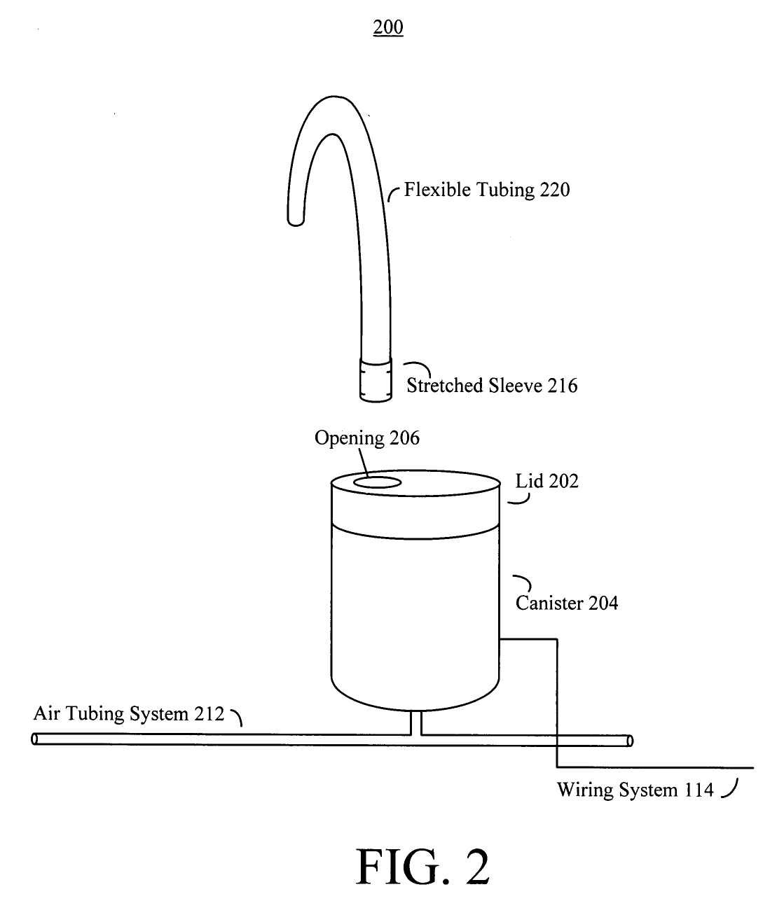

FIG. 2 shows a block diagram of an embodiment of an animal repeller 200. Animal repeller 200 includes lid 202, canister 204, opening 206, air tubing system 212, wiring system 214, stretched sleeve 216, and flexible tubing 220. In other embodiments, encased animal repeller 200 may not have all of the components listed above or may have other components instead of and/or in addition to those listed above.

Animal repeller 200 repels animals. In an embodiment, animal repeller 200 may be an embodiment of one of animal repellers 105a-105n. Animal repeller 200 have a cylindrical shape. In other embodiments, animal repeller 200 may be other shapes.

Lid 202 may cover a canister in which the internal components of the animal repellers 105a-105n are housed, and lid 202 may cover the canister to encase the internal components of animal repeller 200. In an embodiment, lid 202 opens, allowing the user to access the internal components that cause the flexible tubing to flail and closes to seal canister 204, forming the housing of animal repeller 200.

Canister 204 serves as a protective housing for internal components of animal repeller 200. In an embodiment canister 204, when sealed by lid 204, protects the components within canister 204 from exposure to direct sunlight, wind, rain, and other potentially damaging events.

Opening 206 allows a flexible tube and its attachments to protrude from canister 204. In an embodiment, opening 206 may be a circular hole in lid 202. In other embodiments, opening 206 may differ in size, shape, and/or location.

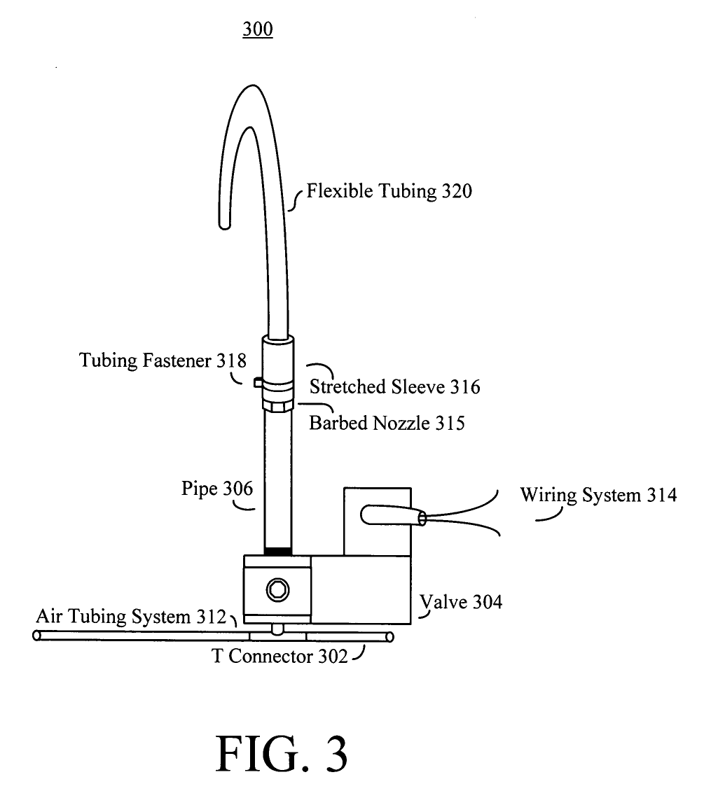

Air tubing system 212 may be an embodiment of air tubing system 112 (which was discussed in conjunction with FIG. 1). Wiring system 214 may be an embodiment of wiring system 114 (which was discussed in conjunction with FIG. 1). Stretched sleeve 216 and flexible tubing 220 will be discussed in conjunction with FIG. 3, below.

FIG. 3 shows a block diagram of an embodiment of the internal components of internal components 300. Internal components 300 includes T connector 302, valve 304, pipe 306, stretched sleeve 316, fastener 318, and flexible tubing 320. In other embodiments, internal components 300 may not have all of the components listed above or may have other components instead of and/or in addition to those listed above.

Internal components 300 may be an embodiment of the internal components of any of animal repellers 105a-105n (which were discussed in conjunction with FIG. 1) or animal repeller 200. In an alternative embodiment, internal components 300 may form an animal repeller that does not have a housing. T connector 302 receives compressed air, and directs at least a portion of the air towards a valve and may allow another portion of the air to pass to the next animal repeller. In an embodiment, T connector 302 may connect to air tubing system 112 and receive air sent by air compressor 102 through air tubing system 112. Air coming from another T connector, going to another T connector, from air compressor 102, or air tank 104 travels through air tubing 112 (air tubing 112 was discussed in conjunction with FIG. 1).

Valve 304 opens and closes to impede (e.g., prevent) or allow the flow of air into pipe 306 (discussed below), thereby directing air into the flexible tube that flails. In an embodiment, valve 304 may be a solenoidal valve, which includes a valve that opens and closes as a result of a solenoid being activated or deactivated. The solenoid of valve 304 may convert electrical energy to mechanical energy. For example, the solenoid may include a coil of wire that surrounds or is in the proximity of a material that responds to a magnetic material, such as a ferromagnetic or ferrimagnetic material. As an electric current flows through the wire, a magnetic field is created by the wire, and the magnetic field pulls on the material that responds to a magnetic field. In an embodiment, the magnetic field may pull or push the material that responds to a magnetic field against a mechanical bias, so that when the magnetic field is shut off, the ferromagnetic material moves back to another position. In other embodiments, the direction of the current in the electromagnet may be changed so that the direction of the magnetic field changes, moving the material that responds to a magnetic field in another direction.

The solenoid of valve 304 may control the state of valve 304 (i.e. whether valve 304 is open or closed). The opening of the valve may allow the entry of air into an animal repeller associated with internal components 300, causing the flexible tubing of internal components 300 to flail. In other embodiments, valve 304 may open and close via a different method. Valve 304 may receive air from T connection 302 and allow air to travel or impede air from traveling to a pipe to which the flexible tube that flails is connected. Valve 304 may receive power from a central power supply that sends power to the valves of the animal repellers 105a-105n. Alternatively, each valve may have an independent power source (e.g., battery supply, solar paneling) for powering the solenoid and/or other switching device that controls the opening and/or closing of valve 304.

Pipe 306 receives, and allows, the passage of air from valve 304 to the flexible tubing of an animal repeller associated with internal components 300 when valve 304 is in an open state. Pipe 306 rises above the housing of valve 304 so that when the flexible tubing flails, the housing of solenoid 304 does not interfere with the flailing. In an embodiment, a barbed nozzle (which will be discussed below) may be attached to pipe 306.

Air tubing system 312 and wiring system 314 may be embodiments of air tubing system 112 and wiring system 114, respectively (which were discussed in conjunction with FIG. 1). Wiring system 314 electrically couples the components of internal components 300, such as the solenoid of valve 304, to control box 110 (which was discussed in FIG. 1).

Barbed nozzle 315 receives the flexible tubing of an animal repeller associated with internal components 300 as an attachment and allows the flow of air from pipe 306 to continue into the flexible tubing of an animal repeller associated with internal components 300. Barbed nozzle 315 may further receive the flexible tubing, which may cover barbed nozzle 315. The barbs of barbed nozzle 315 grip the inner portion of the flexible tubing. In an embodiment, the barbs of barbed nozzle 315 dig into the flexible tubing when the flexible tubing is moved in the opposite of the direction in which it was attached. This may help keep the flexible tubing attached to barbed nozzle 315. Barbed nozzle 315 is optional. For example, the stretched sleeve and/or flexible tubing may connect directly to pipe 306.

Stretched sleeve 316 covers the point of connection between barbed nozzle 315 and the flexible tubing of an animal repeller associated with internal components 300. In an embodiment, stretched sleeve 316 may be a tube (e.g., a segment of surgical tubing) and/or may be elastic. Stretched sleeve 316 may aid in securing the flexible tubing to barbed nozzle 315. A lower portion of stretched sleeve 316 engages, covers, and/or grips barbed nozzle 315, and an upper portion of stretched sleeve 316 engages, covers, and/or grips the flexible tubing. The stretching of stretched sleeve 316 to fit around barbed nozzle 315 and the flexible tubing causes stretched sleeve 316 to grip barbed nozzle 315 and the flexible tubing. A secondary benefit of stretched sleeve 316 is that stretched sleeve 316 may prevent damage to the portion of the flexible tubing of an animal repeller associated with internal components 300 that attaches to barbed nozzle 315, thereby decreasing the potential for system failure and the labor costs associated with replacing components. Further, stretched sleeve 316 may relieve stress at the vulnerable point where the flexible tubing of an animal repeller associated with internal components 300 connects to barbed nozzle 315 (similar to a knee or elbow brace that might be used to strengthen a weak or sensitive joint). Stretched sleeve 316 is optional.

Fastener 318 holds the flexible tubing of an animal repeller associated with internal components 300 on barbed nozzle 315 and/or pipe 306. Fastener 318 wraps around barbed nozzle 315, stretched sleeve 316 and the flexible tubing holding the flexible tubing on pipe 306. Tightening fastener 318 may tighten the grip of stretched sleeve 316 on the point of connection between barbed nozzle 315 and the flexible tubing of an animal repeller associated with internal components 300. In an embodiment, fastener 318 may be a band (e.g. a tie) that wraps around stretched sleeve 316 at a lower portion where the nozzle is wider. Fastener 318 may further prevent leakage of air and other negative effects associated with a loosening of the connection between the flexible tubing of an animal repeller associated with internal components 300 and barbed nozzle 315. Fastener 318 is optional.

Flexible tubing 320 is tubing that moves erratically and/or generates noise as air passes through flexible tubing 320. In an embodiment, flexible tubing 320 is composed of supple and adjustable material that is limp and that hangs downward when no air is being forced through flexible tubing 320. Flexible tubing 320 tends to move, vibrate, flap, and/or flutter when air passes through flexible tubing 320.

The upright mounting, influence of gravity, and the grasping and holding by stretched sleeve 316 causes flexible tubing 320 to be initially bent over in a first direction. As air escapes flexible tubing 320, the air flow initially causes the flexible tubing 320 to straighten and stand straight upwards. However, since flexible tubing 320 moves rapidly into the upright position, flexible tubing 320 is still in motion when flexible tubing 320 arrives into the upright position. The motion of flexible tubing 320 gives flexible tubing 320 a momentum, and the momentum causes flexible tubing 320 to continue to move in the same direction as when the flexible tubing moved to arrive in the upright position (instead of stopping in the upright position). As a result of the continued movement, flexible tubing 320 tends to bend over in the opposite direction from the direction in which flexible tubing was initially bent. Once flexible tubing 320 bends over completely or stops moving in its initial direction of movement for other reasons, the air flowing through flexible tubing 320 tends to push flexible tubing 320 back towards the upright position causing flexible tubing 320 to reverse its direction of motion, starting the process over again. The repeated pushing of flexible tubing 320 to an upright position combined with flexible tubing 320 overshooting the upright position results in a flailing motion. The motion induced tends to be erratic in nature.

The air rushing through flexible tubing 320 creates a noise. As the configuration of flexible tubing 320 changes while moving, the noise tends to change. Additionally, if the air rushes through flexible tubing 320 fast enough, flexible tubing 320 hits (or bangs against) lid 202, canister 204, and/or other object within the path of travel of flexible tubing 320 (FIG. 2) prior to reversing the direction of travel of flexible tubing 320. The hitting of the flexible tubing 320 on lid 202, canister 204 and/or other objects creates additional noises. Since the motion of flexible tubing 320 tends to be erratic, the noises that depend on the configuration and/or motion of flexible tubing 320 are also erratic. The result is that after an animal enters an area covered by animal repelling system 100 (FIG. 1) a sudden and erratic motion and noise is generated by flexible tubing 320. Since the motion and noises generated by an animal repeller associated with internal components 300 are erratic and sudden, it scares the animals. Also, since the motion and noise is sudden and erratic the animals tend not to get accustomed to the noise and motion. Since the animals tend not to get accustomed to the noise and motion, the animals can be scared away and be repelled repeatedly over and over again by the same animal repeller.

In an embodiment, the end of flexible tubing 320 that is furthest from lid 202 and canister 204 (e.g., the distal end) may be colored with a bright color that has a high contrast with the rest of flexible tubing 320 and/or has a high contrast with the background scenery, so that the motion of flexible tubing 320 is more noticeable and has a higher likelihood scaring an animal. In other embodiments, flexible tubing 320 may be induced to generate motion and sound via a different manner.

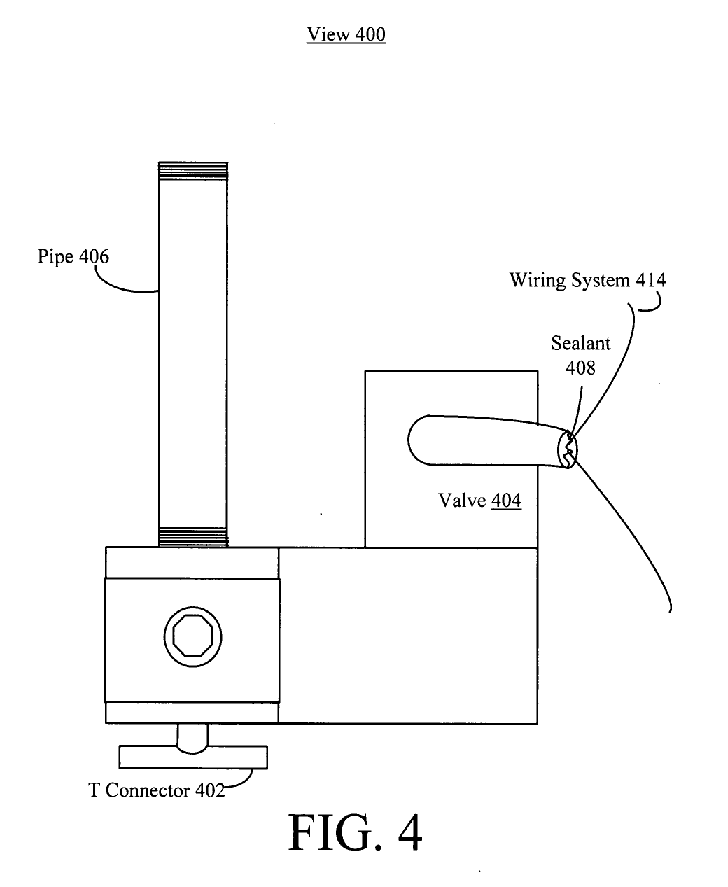

FIG. 4 shows a block diagram of animal view 400 of an embodiment of internal components 300 with sealant covering the wires at a point of connection. View 400 includes, T connector 402, valve 404, pipe 406, sealant 408 and wiring system 414. In other embodiments, animal view 400 may not have all of the components listed above or may have other components instead of and/or in addition to those listed above.

In embodiments, T connector 402, valve 404, pipe 406 and wiring system 414 may be an embodiment of T connector 302, valve 304, pipe 306 and wiring system 314, respectively, which were discussed above in conjunction with FIG. 3.

Sealant 408 creates a water tight seal between the wires of wiring system 414 at their points of connection. Sealant 408 may protect the segments of wiring system 414 from water and/or other unfavorable weather conditions. In an embodiment, sealant 408 may be a silicone sealant. In other embodiments, wiring system 414 may be protected in other ways.

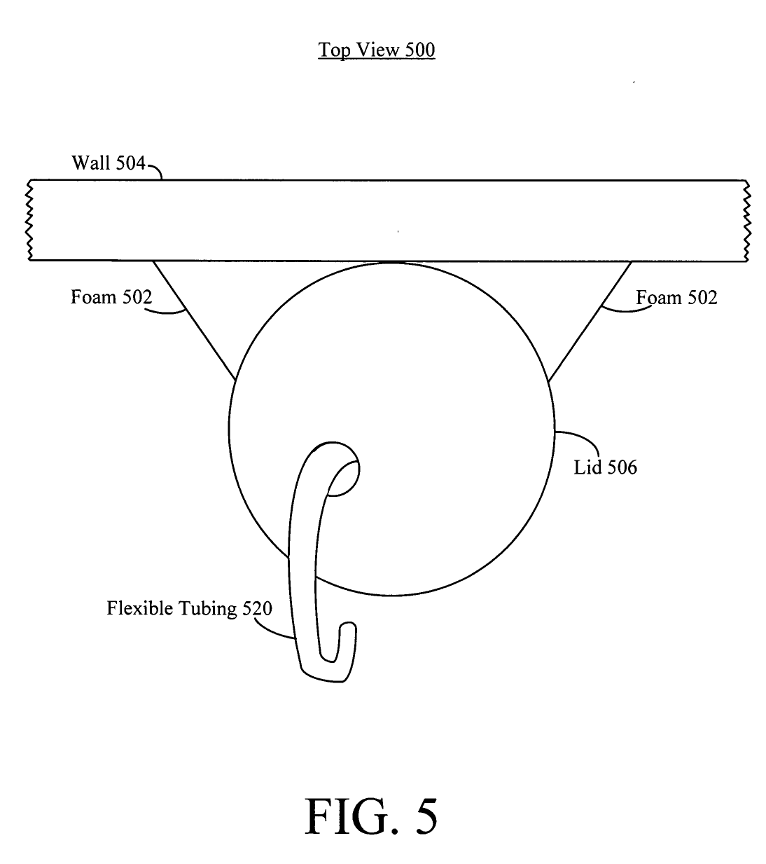

FIG. 5 shows a block diagram of an embodiment of animal repeller 200 from a top view 500. Top view 500 includes foam 502, wall 504, lid 506 and flexible tubing 520. Other embodiments of view 500 may not have all of the components listed above or may have other components instead of and/or in addition to those listed above.

Top view 500 shows a manner in which animal repeller 200 (FIG. 2) may be secured to a wall (e.g., on a roof top of a building). In an embodiment, foam 502 may prevent flexible tubing of an animal repeller 200 (discussed in FIG. 3) from getting caught between an animal repeller 200 and the wall on which animal repeller 200 is mounted. In an embodiment, foam 502 fills an open space between an animal repeller 200 and a wall or other surface onto which animal repeller 200 is mounted. Foam 502 thereby limits the likelihood of flexible tubing 520 being snagged and/or becoming stuck due to its flailing activity, heavy winds and/or manipulation by animals. In other embodiments foam 502 may be replaced with another material that fills the space between animal repeller 200 and a surface to which animal repeller 200 is mounted or foam 502 may not be necessary.

Wall 504 is a surface onto which animal repeller 200 may be installed. In an embodiment, wall 504 may be part of a roof, building, or other area where it is desirable to keep animals from gathering. Wall 504 may be replaced with another suitable surface for securing animal repeller 200, such as the side of a rock. Lid 506 may be an embodiment of lid 202 which was discussed in conjunction with FIG. 2.

FIG. 6 shows a block diagram of an embodiment of control box 100. Control box 600 includes power strips 602a and 602b, power supply units 605a and 605b, timer 606, valve power supply 608, and wiring system 614. In other embodiments, control box 600 may not have all of the components listed above or may have other components instead of and/or in addition to those listed above.

Control box 600 may be an embodiment of control box 110, which was discussed above in conjunction with FIG. 1. Power strips 602a and 602b connect to a power source and make electricity accessible to the other components within control box 600. In an embodiment, power strips 602a and 602b connect to a wall outlet and may be a subset of a larger number of power strips. In other embodiments, power strips 602a and 602b may connect to a different power source and/or there may be only one power strip.

Power supply units 605a and 605b convert electricity from the voltage, frequency, and/or current that is available from a power source (such as the wall) to a voltage, current, and/or frequency that is needed by other components of control box 600 and/or animal repeller system 100. In an embodiment, power supply units 605a and 605b may provide power to at least a timer, sensor 108 (FIG. 1), and valve 304 (FIG. 3). In other embodiments, power supply units 605a and 605b may power other components in addition to or instead of the components mentioned above, may be independent sources of power, and/or may connect to a bus that routes power to at least one attached component. Although two power supplies are illustrated in FIG. 6 in other embodiments there may be only one power supply or any number of power supplies.

Timer 606 controls how long animal repellers 105a-105n remain active after activated. In an embodiment, timer 606 may control how long of a delay exists between sensing the presence of an animal and activating one or more of animal repellers 105a-105n. For example, in order to maximize the surprise element of the activation of animal repellers 105a-105n, it may be desirable to wait long enough to allow the animal to enter deep into the area protected by animal repellers 105a-105n (FIG. 1). In an embodiment, timer 606 receives input from a sensor configured to detect the presence of animals, such as sensor 108 (FIG. 1), which serves as a trigger that starts timer 606. Upon receiving input recognized as a trigger, timer 606 sets a length of time that electricity is allowed to flow to animal repellers 105a-105n, which is the duration of time that flexible tubing 320 (FIG. 3) is allowed to flail after being triggered.

Valve power supply 608 routes power to valve 304 (FIG. 3). In an embodiment, valve power supply 608 may receive an electrical current for a period of time that is set and/or controlled by timer 606, and may transmit the current to one or more of animal repellers 105a-105n. Wiring system 614 may be an embodiment of wiring system 114 (FIG. 1).

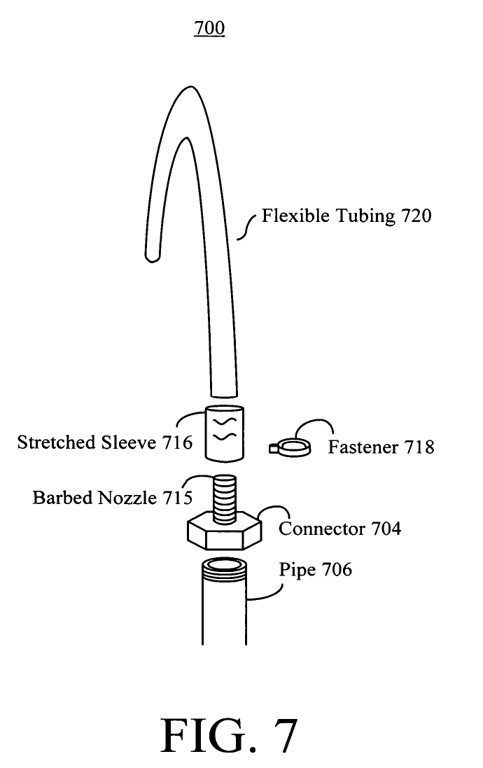

FIG. 7 is an exploded diagram of an embodiment of the connection 700 between flexible tube 320 and pipe 306 (FIG. 3). Connection 700 includes connector 704, barbed nozzle 715, stretched sleeve 716, fastener 718, and flexible tubing 720. In other embodiments connection 700 may not have all of the components listed above or may have other components instead of and/or in addition to those listed above.

Connector 704 joins barbed nozzle 715 (discussed below) and pipe 706. In an embodiment, connector 704 may be a male connector that joins a female connector (e.g., barbed nozzle 715).

Pipe 706, barbed nozzle 715, stretched sleeve 716, fastener 718 may be an embodiment of pipe 306, barbed nozzle 315, stretched sleeve 316, fastener 318, flexible tubing 320, respectively, which were discussed in conjunction with FIG. 3. In addition to showing connector 704, FIG. 7 shows the manner in which connector 704, pipe 706, barbed nozzle 715, stretched sleeve 716, fastener 718, and flexible tubing 720 are connected to one another in a manner that is clearer than what is shown in FIG. 3. Connector 704 may be replaced with a different connector and/or barbed nozzle 715 may be integral with pipe 706. In an embodiment that does not include barbed nozzle 715 in the animal repeller, connector 704 may also not be included in the animal repeller.

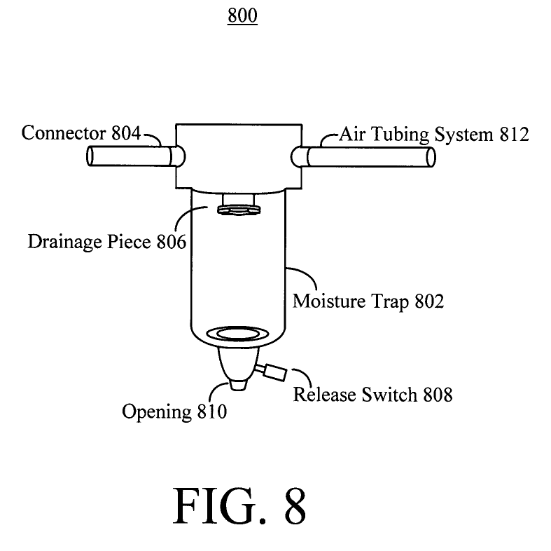

FIG. 8 is a block diagram of an embodiment of a moisture filter 800. Moisture filter 800 includes moisture trap 802, connector 804, drainage piece 806, release switch 808, and opening 810. In other embodiments, moisture filter 800 may not have all of the components listed above or may have other components instead of and/or in addition to those listed above.

In an embodiment, moisture filter 800 may be an embodiment of moisture filter 103. Moisture trap 802 collects moisture from air flowing within moisture trap 802. In an embodiment, moisture trap 802 is connected to air tubing system 112 in a manner such that moisture trap 802 may collect moisture filtered from compressor connector 104 (e.g., by connecting moisture trap 804 to place where air exits air compressor 104). By connecting moisture trap 802 to the source of the air, air compressor 104, moisture trap 802 may collect water from the air of the entire animal repelling system 100. In another embodiment, there may be many moisture traps, which may be connected in a variety of other locations to collect moisture from the air exiting or entering any combination of enjoined segments of animal repelling system 100 (FIG. 1) through which air passes.

Connector 804 is an optional component that connects moisture filter 800 to a component of animal repelling system 100 (FIG. 1). In an embodiment, connector 804 may connect moisture filter 800 to compressor 102 (FIG. 1). In an embodiment, connector 804 is made from a rigid material so as to suspend moisture filter 800 in a position that allows moisture to collect on the bottom of moisture filter 800.

Drainage piece 806 captures water vapor, allowing it to condense and fall. In an embodiment, drainage piece 806 resides in a fixed position within moisture filter 800 that places it in the path of air flowing into the rest of animal repelling system 100 (FIG. 1). Drainage piece 806 is fashioned to allow air to pass while water vapors strike its surface. As a consequence of hitting the surface of drainage piece 806, multiple water vapors encounter other water vapors and condense until their weight causes them to fall into moisture trap 802.

Release switch 808 allows collected water to be emptied. In an embodiment, release switch 808 features a button, lever, or other component that opens an opening in the underside of moisture trap 802, causing the contents of moisture trap 802 to be released. The contents of moisture trap 802 may be released into a number of different places of disposal, such as the ground, a tray or another container.

Opening 810 is a an opening (e.g. hole) in the lower section of moisture trap 802 though which water is released from moisture filter 800. In an embodiment, opening 810 is controlled by release switch 808.

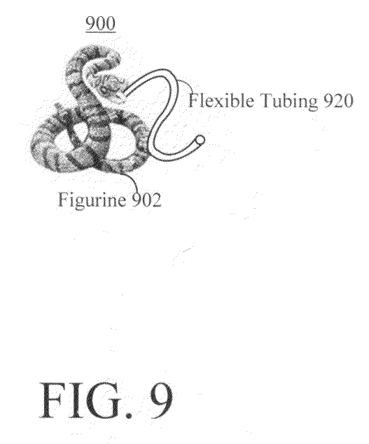

FIG. 9 is a block diagram of an embodiment of animal repeller 900. Animal repeller 900 includes figurine 902 and flexible tubing 920. In other embodiments, animal repeller 900 may not have all of the components listed above or may have other components instead of and/or in addition to those listed above. In an embodiment, components of animal repeller 900 may be similar to those associated internal components 300, such as T connector 302, valve 304, pipe 306, wiring system 312, stretched sleeve 316, barbed nozzle 315 and fastener 318 (FIG. 3). The components of animal repeller 900 may be installed into the ground beneath figurine 902 and/or within figurine 902. Further, figurine 902 may be modeled to resemble a snake for aesthetic purposes and possibly to blend in with the landscape. Flexible tubing 920 may extend from the area modeled to represent a snake's mouth. Flexible tubing 920 is an embodiment of flexible tubing 320, which was discussed in conjunction with FIG. 3. In other embodiments, the components of animal repeller 900 may be installed in other concealed locations and flexible tubing 920 may have a different placement.

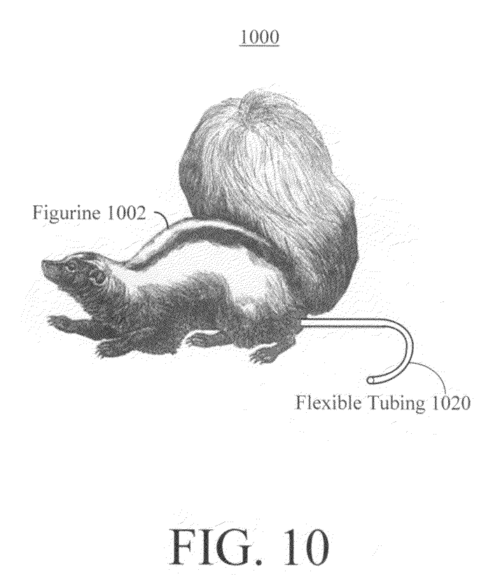

FIG. 10 is a block diagram of an embodiment of animal repeller 1000. Animal repeller 1000 includes, figurine 1002 and flexible tubing 1020. In other embodiments, animal repeller 1000 may not have all of the components listed above or may have other components instead of and/or in addition to those listed above. In an embodiment, animal repeller 1000, figurine 1002, and flexible tubing 1020 are similar to animal repeller 900, figurine 902, and flexible tubing 920, which were discussed in conjunction with FIG. 9. However, figurine 1002 looks like a skunk instead of a snake.

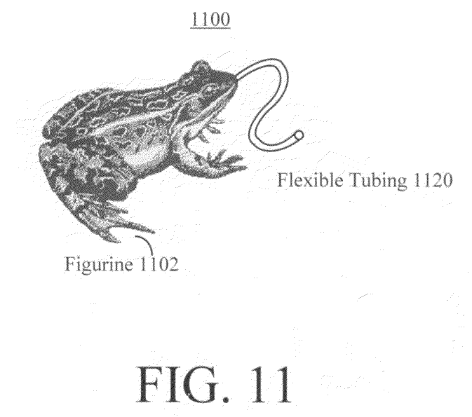

FIG. 11 is a block diagram of an embodiment of animal repeller 1100. Animal repeller 1100 includes, figurine 1102 and flexible tubing 1120. In other embodiments, animal repeller 1100 may not have all of the components listed above or may have other components instead of and/or in addition to those listed above. In an embodiment, animal repeller 1100, figurine 1102, and flexible tubing 1120 are similar to animal repeller 900, figurine 902, and flexible tubing 920, respectively, which were discussed in conjunction with FIG. 9. However, figurine 1102 looks like a frog instead of a snake.

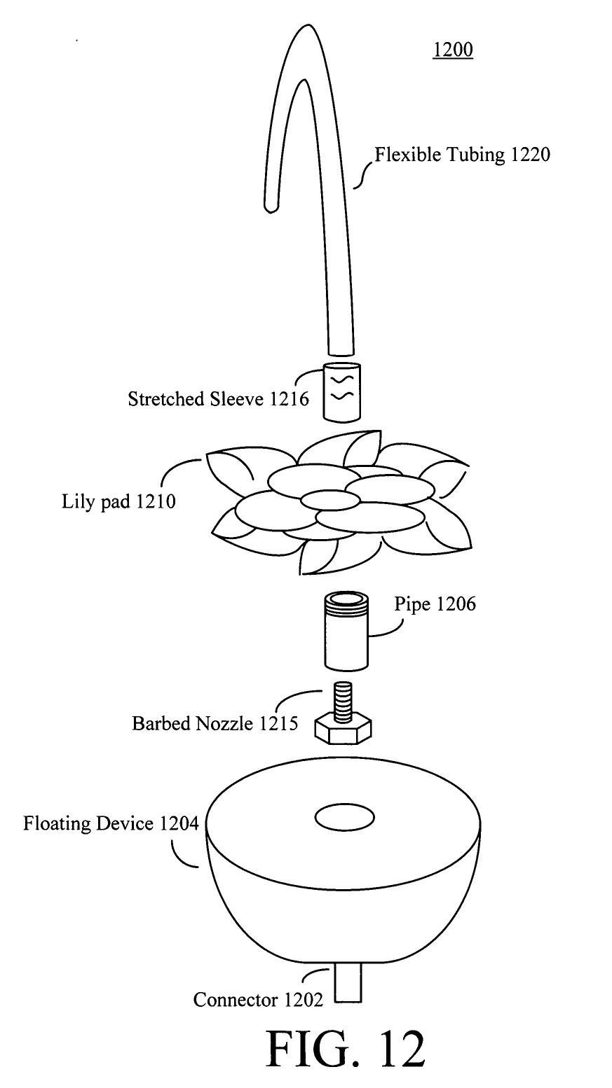

FIG. 12 is a block diagram of an embodiment of animal repeller 1200. Animal repeller 1200 includes connector 1202, floating device 1204, pipe 1206, lily pad 1210, barbed nozzle 1215, stretched sleeve 1216, and flexible tubing 1220. In other embodiments, animal repeller 1200 may not have all of the components listed above or may have other components instead of and/or in addition to those listed above.

Animal repeller 1200 frightens animals that are near or within a body of water and is therefore designed with the capability to float. In an embodiment, animal repeller 1200 may be disguised to look like a lily pad. Alternatively animal repeller 1200 may be disguised to look like another item commonly seen at the surface of a body of water, such as a rock, a turtle, a frog, a fish, a duck, a goose, a swan, another water bird, another water animal, another water vegetation, or another item associated with water. Connector 1202 may be similar to a T connector 302, which was discussed in conjunction with FIG. 3.

Floating device 1204 is composed of materials that cause all or part of animal repeller 1200 to float above the surface of a body of water. For example, floating device 1204 may be a piece of wood or plastic. Pipe 1206 may be an embodiment of pipe 306, which was discussed in FIG. 3. Lily pad 1210 is a covering for floating device 1204 that resembles a lily pad. Lily pad 1210 obscures or conceals floating device 1204 from view. Lily pad 1210 may have a more aesthetically pleasing look than floating device 1204 or may blend into the surroundings better than floating device 1204.

Barbed nozzle 1215, stretched sleeve 1216, and flexible tubing 1220 may be an embodiment of barbed nozzle 315, stretched sleeve 316, and flexible tubing 1220, respectively, which were discussed in conjunction with FIG. 3. Flexible tubing 1220 may extend from the center of lily pad 1210. In other embodiments, the components of animal repeller 1200 may be installed in other concealed locations that are outside a body of water, and flexible tubing 1220 may have a different placement on animal repeller 1200.

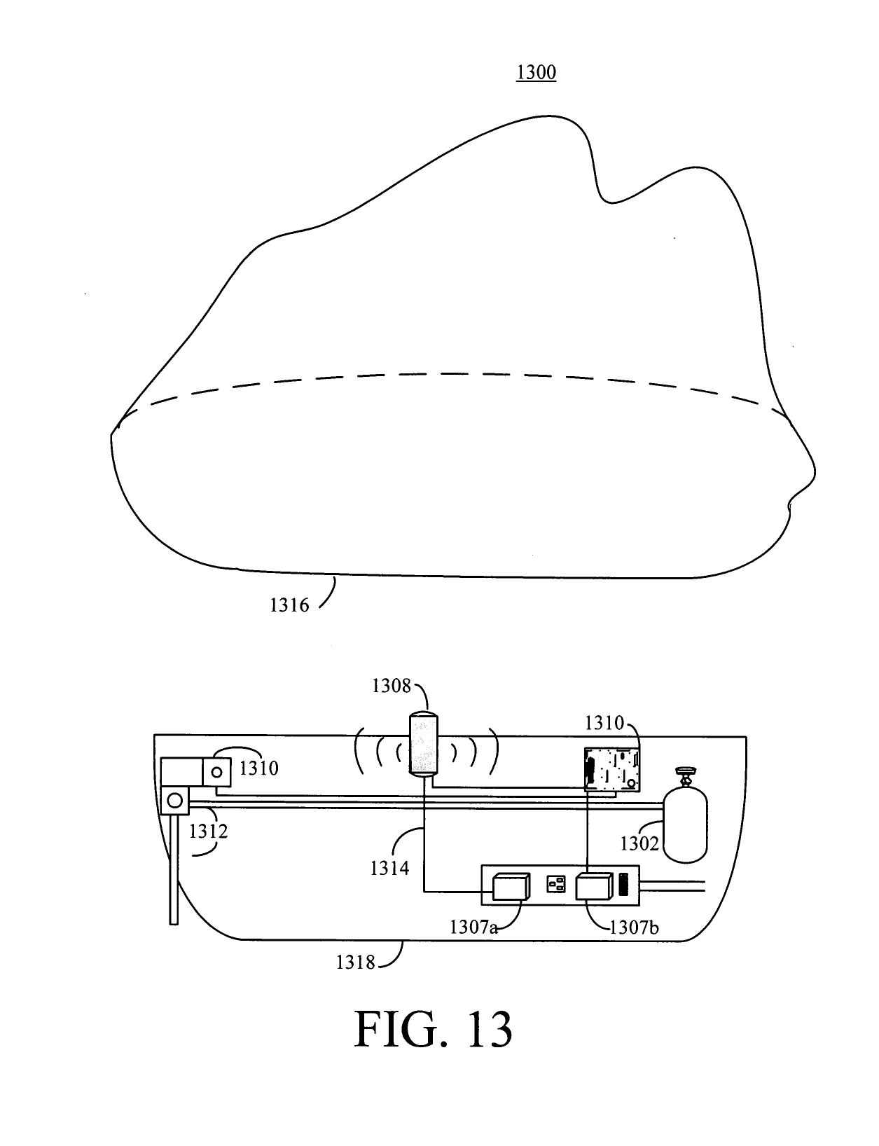

FIG. 13 shows a diagram of an embodiment of an animal repelling system 1300. Animal repelling system 1300 includes, air tank 1302, switch 1306, sensor 1308, timer 1310, air tubing system 1312 and wiring system 1314, boulder 1316 and bottom 1318. In other embodiments, animal repelling system 1300 may not have all of the components listed above or may have other components instead of and/or in addition to those listed above.

Animal repelling system 1300 may reduce the presence of animals in a location and thereby the negative aftereffects associated with the presence of animals. In an embodiment, animal repelling system 1300 may be an embodiment of animal repelling system 100, with an air tank replacing the air compressor of animal repelling system 100. In an embodiment, the components of animal repelling system 1300 may be attached to portable devices, such as figurines, objects resembling elements of a natural landscape (such as a boulder) and/or floating constructs modeled to have a particular aesthetic look or to blend in with an environment where animal repelling system 1300 is installed. In an embodiment, components of animal repelling system 1300 may correspond directly to those within animal repelling system 100 (which were discussed in conjunction with FIG. 1). In other embodiments, the components of animal repelling system 1300 may be attached to stationary devices and/or may not correspond directly to those within animal repelling system 100.

Air tank 1302, switch 1306, power supply units 1307a and 1307b, sensor 1308, timer 1310, air tubing system 1312, and wiring system 1314 are similar to air tank 102, switch 106, sensor 108, air tubing system 112, and wiring system 114, which were discussed in conjunction with FIG. 1. Power supply units 1307a and 1307b are similar to power supply units 605a and 605b, respectively, which were discussed in conjunction with FIG. 6. Timer 1310 is similar to timer 606 which was discussed in conjunction with FIG. 6. Boulder 1316 is an example of a piece of landscape that is hollow, and attaches to bottom 1318 (discussed below) covering and concealing components of animal repelling system 1300. In an embodiment, boulder 1316 may resemble a rock. In other embodiments boulder 1316 may resemble other objects that may be elements of a natural landscape and may or may not conform to the shape of bottom 1318.

Bottom 1318 supports components of animal repelling system 1300. Boulder 1316 may be coupled to bottom 1318 or cover bottom 1318 so that the components supported by bottom 1318 are concealed.

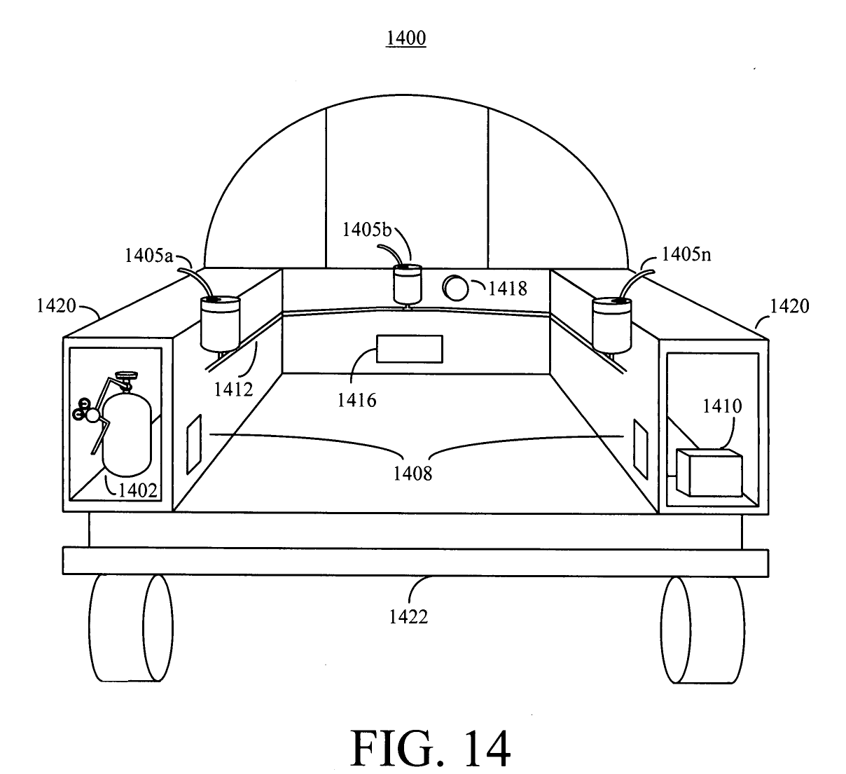

FIG. 14 shows a diagram of an embodiment of an animal repelling system 1400. Animal repelling system 1400 includes, air supply 1402, animal repellers 1405a-1405n, switch 1406, sensor system 1408, control box 1410, air tubing system 1412, visual device 1418, wall 1420 and configured vehicle 1422. In other embodiments, animal repelling system 1400 may not have all of the components listed above or may have other components instead of and/or in addition to those listed above.

In an embodiment, animal repelling system 1400 may be configured as a demonstration of an animal repelling system. Although not shown, animal repelling system may include a power source, which delivers power to the components of animal repelling system 1400. In an embodiment, the power source for animal repelling system 1400 may be a car battery, another battery, and/or animal system 1400 may have a plug for connecting with an external outlet.

Air supply 1402 may include an air tank (similar to air tank 102 of FIG. 1) and/or air compressor (similar to air compressor 104 of FIG. 1), which is appropriate for installing within a vehicle. In an embodiment, air supply 1402 is located within a wall.

In an embodiment, animal repellers 1405a-1405n, switch 1406, sensor 1408, control box 1410, and air tubing system 1412 are similar to animal repellers 105a-105n, switch 106, sensor 108, control box 110, and air tubing system 112, respectively, which were discussed in conjunction with FIG. 1.

Audio device 1416 produces noise when activated by an animal detecting sensor. In an embodiment, the combination of audio device 1416 and strobe light 1418 are one embodiment of the audio-visual panel of FIG. 1.

Strobe light 1418 is visual device that produces flashes of light at regular intervals. In an embodiment, the combination of audio device 1416 and strobe light 1418 are one embodiment of the audio-visual panel of FIG. 1 (as discussed above in conjunction with audio device 1416).

Wall 1420 is a housing (e.g. cabinet) built in/on configured vehicle 1422 (discussed below) for components of animal repelling system 1400, such as air supply 1402 and control box 1410. In FIG. 14, the panels have been removed from the ends of wall 1420 so that control box 1410 and air supply 1402 can be seen. Configured vehicle 1422 is a vehicle, such as a truck, that has been modified to receive and power animal repelling system 1400. In an embodiment, configured vehicle 1422 may have cabinets, shelves and other units installed to house devices, cabling, and connections to a power source. Configured vehicle 1422 may be any vehicle having a rear area of an appropriate size and shape for setting up the demo, such as a pickup truck. For example, vehicle 1422 may be a Toyota™ Tundra®. In other embodiments, configured vehicle 1422 may have other installed parts in addition to or instead of the parts mentioned above and may be one of many types of vehicles (e.g., a car, jeep, mobile platform, etc.).

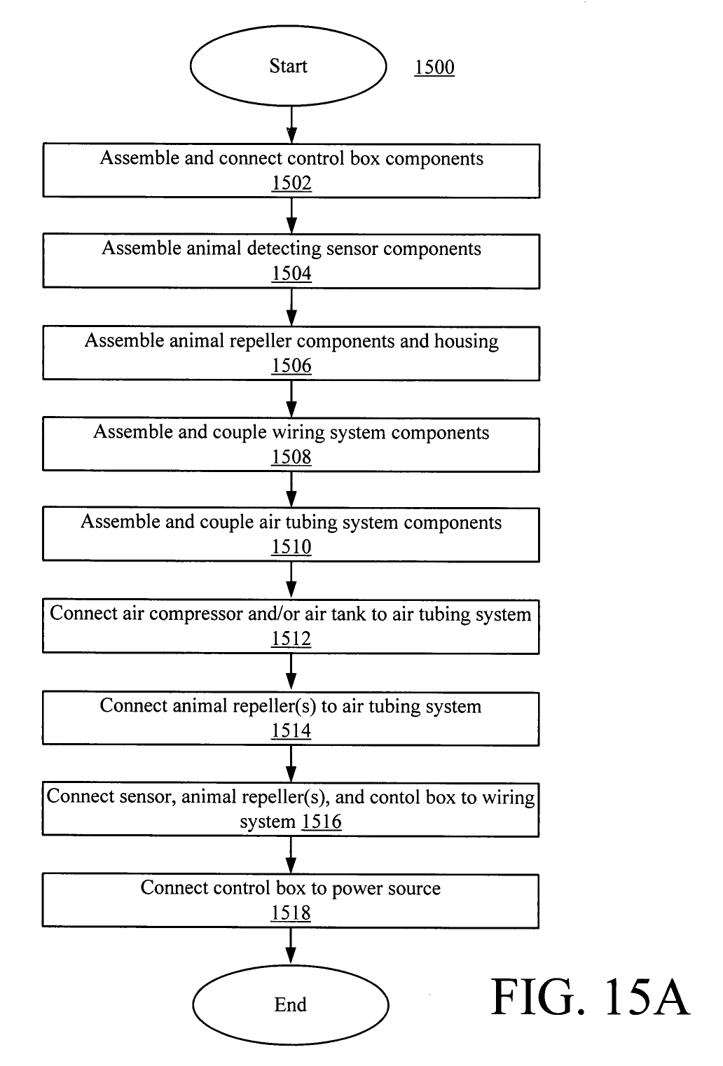

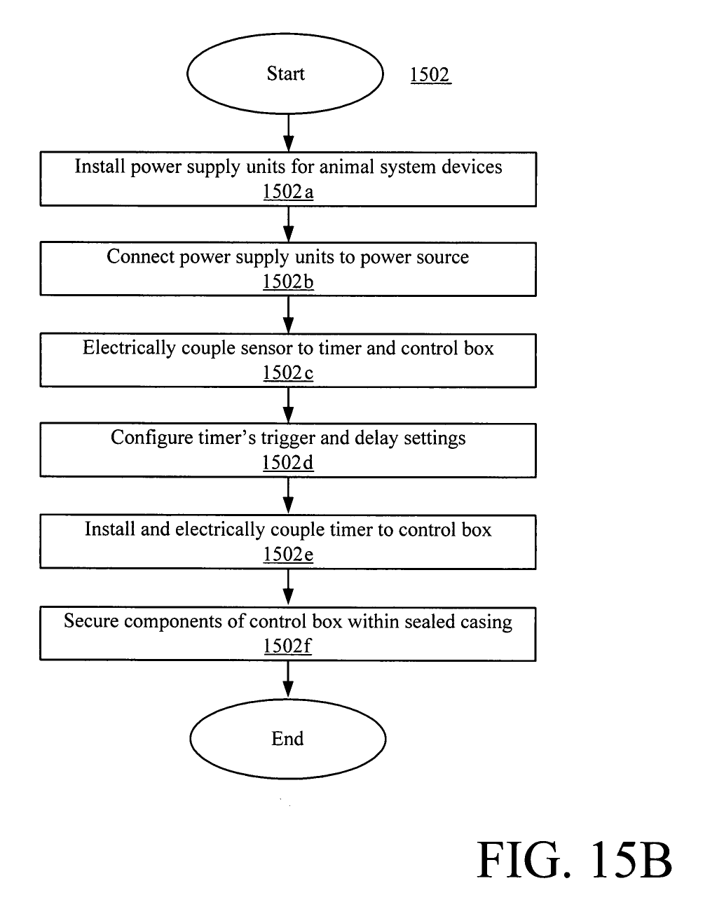

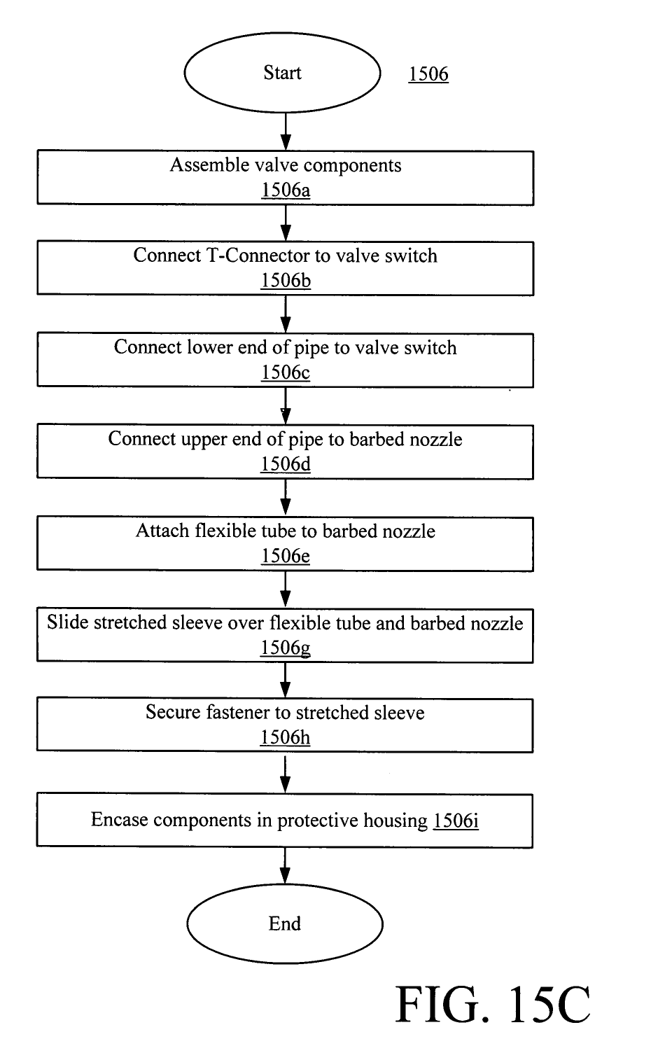

FIG. 15 is a flowchart of an example of a method 1500 of making an animal repelling system. In step 1502, a control box, such as control box 110 (FIG. 1), is assembled (as will be discussed further in conjunction with FIG. 15B). In step 1504, the components of an animal detecting sensor such as sensor 108 (FIG. 1) are assembled. Step 1504 may include installing a transmitter and receiver for sound, light or radio waves in a way that detects motion or the presence of an animal or an infrared sensor for detecting heat within a perimeter within which animals may be unwanted. In step 1506, the components of an animal repeller, such as internal components 300 (FIG. 3), are assembled (as will be discussed further in conjunction with FIG. 15C). Step 1506 may include assembling valve 304, a barbed nozzle 315, a flexible tubing 320, and a pipe 306, and further securing flexible tubing 320 to barbed nozzle 315 with sleeve 316 and fastener 318 (FIG. 3). In step 1508, a wiring system, such as wiring system 114 (FIG. 1), is formed. Step 1508 may include coupling wiring for transmitting positive and negative electrical currents to appropriately corresponding connectors on other wires and/or devices. In step 1510, the components of an air tubing system, such as air tubing system 112 (FIG. 1), are assembled. In step 1512, an air tubing system, such as air tubing system 112 (FIG. 1), is connected to an air supply. Step 1512 may include, attaching moisture filter 800 (FIG. 8) to an air supply, such as air compressor 102 (FIG. 1). For example, step 1512 may include coupling an air tubing system to an air compressor and/or air tank, such as air compressor 102 and/or air tank 104 (FIG. 1) optionally via a moisture filter 800. In step 1514 animal repellers 105a-105n, are connected to air tubing system 112. Step 1514 may include connecting T connectors, such as T connector 302, to air tubing system 112, thereby connecting animal repellers 105a-105n to air tubing 112. In step 1516, a control box 110, animal repellers 105a-105n, and sensor 108 are connected to the wiring system 114 (FIG. 1). In step 1518, a control box 110 is connected to a power source. In an embodiment, step 1518 may include coupling control box 110 to an external power source, such as a wall outlet.

In an embodiment, each of the steps of method 1500 is a distinct step. In another embodiment, although depicted as distinct steps in FIG. 15, steps 1502-1518 may not be distinct steps. In other embodiments, method 1500 may not have all of the above steps and/or may have other steps in addition to or instead of those listed above. The steps of method 1500 may be performed in another order. Sub-steps of the steps and sub-steps of the sub-steps listed above as part of method 1500 may be used to form their own method.

FIG. 15B is a flowchart of an example of a method for carrying out step 1502 of assembling control box 110 (FIG. 1). In step 1502a power supply units for animal detecting sensor 108 (FIG. 1) and at least a valve 304 (FIG. 3), are installed (such as power supply unit 602a and 602b of FIG. 6. Step 1502a may include a separate power supply unit 602a or 602b for animal detecting sensor 108 (which may have one or more components), and another power supply unit for one or more valves, such as valve 304. Power supply units 602a and/or 602b may be wired directly or indirectly to a device that routes electricity to sensor 108 and at least one valve 304. In step 1502b, power supply units are connected to a power source. Step 1502b may include attaching power supply unit 602a or 602b into one or more power strips 605a and 605b (FIG. 6) and connecting power strip 605a or 605b to an external power source (e.g., a wall outlet). In step 1502c sensor 106 (FIG. 1) is electrically coupled to timer 606 (FIG. 6). Step 1502c may include attaching electrical wiring from sensor 108 to corresponding terminals on timer 606. In step 1502d the trigger and delay settings of a timer, such as timer 606, are configured. Step 1502d may include adjusting one or more controls, switches, knobs, or other controls of timer 606 to establish a trigger (e.g., receiving an electrical pulse of a positive, negative or alternating current type) that will signal a timer to route electricity to devices regulated by timer 606. Step 1502d may further include adjusting one or more controls on a timer to specify a delay period during which electricity will be transmitted by timer 606 to its dependent devices.

In step 1502e, timer 606 (FIG. 6) is installed within control box 110 (FIG. 1) and connected to a power supply unit, such as power supply unit 602a or 602b (FIG. 6). Step 1502e may include placing timer 606 in a fixed mounting within control box 110, and wiring timer 606 to the devices that timer 606 will regulate, such as animal repellers 10a-105n. As part of step 1502e, timer 606 may be connected to power strip 605a and/or 605b via a power supply unit 602a or 602b (FIG. 6).

In step 1502f, the components of a control box 110 (FIG. 1) are enclosed within a protective casing. Step 1502f may include placing cover 616 (FIG. 6) onto control box 110 and sealing the cover to a housing for components via removable fasteners, such as screws.

In an embodiment, each of the steps of method 1502 is a distinct step. In another embodiment, although depicted as distinct steps in FIG. 15B, steps 1502a-1502f may not be distinct steps. In other embodiments, method 1502 may not have all of the above steps and/or may have other steps in addition to or instead of those listed above. The steps of method 1502 may be performed in another order.

FIG. 15C is a flowchart of an example of a method 1506 of making any of animal repellers 105a-105n (FIG. 1). In step 1506a the components of a any of animal repellers 105a-105n are assembled. Step 1506a may include, assembling T connector 302, valve 304, pipe 306, barbed nozzle 315, stretched sleeve 316, fastener 318, and flexible tubing 320. In step 1506b electrical wiring is coupled to the terminals of an electromechanical switch that powers a valve 304 (FIG. 3). In step 1506c, T connector 302 (FIG. 3) is connected to the valve 304. In step 1506d, pipe 306 (FIG. 3) is attached to the valve 304. In step 1506e, pipe 306 is connected to barbed nozzle 315 (FIG. 3). In step 1506f, flexible tubing 320 (FIG. 3) is connected to barbed nozzle 315. In step 1506g flexible tubing 320 is slid on barbed nozzle 315. In step 1506h, stretched sleeve is stretched to cover flexible tubing 320 at the point of coupling with barbed nozzle 315. In step 15061, fastener 318 (FIG. 3) is fastened around stretched sleeve 316 so as to hold stretched sleeve 316 on flexible tube 320 and barbed nozzle 315.

In an embodiment, each of the steps of method 1506 is a distinct step. In another embodiment, although depicted as distinct steps in FIG. 15C, steps 1506a-1506i may not be distinct steps. In other embodiments, method 1506 may not have all of the above steps and/or may have other steps in addition to or instead of those listed above. The steps of method 1506 may be performed in another order.

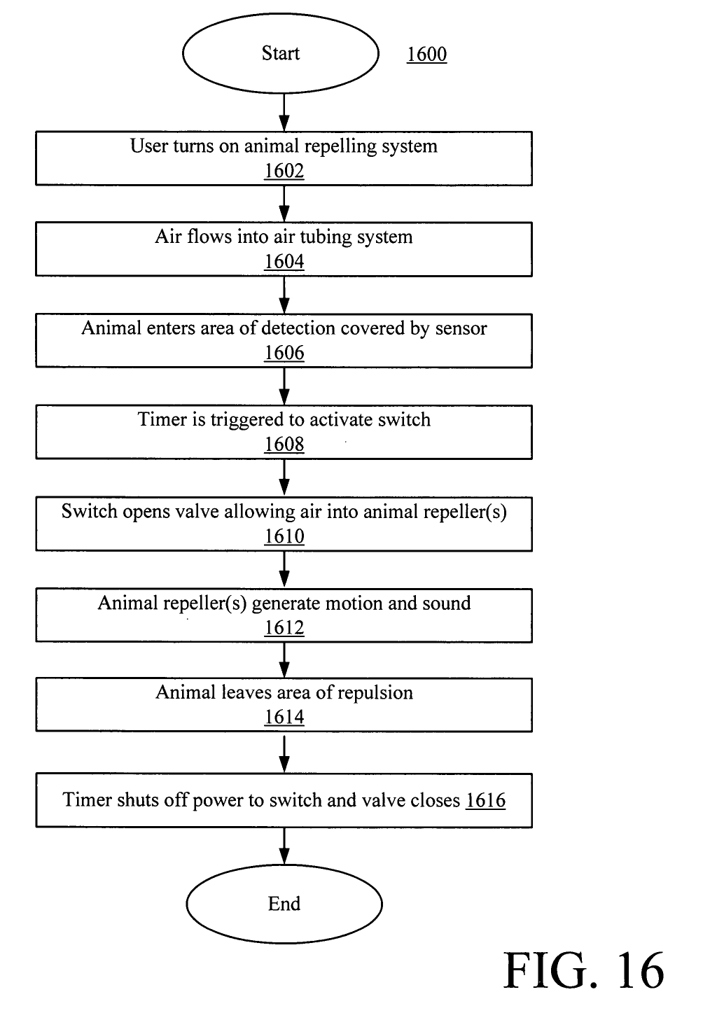

FIG. 16 is a flowchart of an example of a method 1600 of using animal repelling system 100 (FIG. 1). In step 1602, a user turns on animal repelling system 100. Step 1602 may include pressing a power button, switch or other control. In step 1604, as a result of step 1602, air flows into air tubing system 112 (FIG. 1) of animal repelling system 100. Step 1604 may include the powering on and the releasing of air from air compressor 102 (FIG. 1) as a result of step 1602 and/or the manual opening of an air tank's release valve. In step 1606, an animal enters a perimeter within which sensor 108 (FIG. 1) is capable of detecting animals. In step 1608 sensor 108 detects the animal presence. For example, the animal presence may cause an interruption between the sending and receiving of a transmission (e.g., of a sound wave, radio wave, or light beam) between the transmitter and receiver of a sensor, and/or receiving heat emitted by the animal. Step 1608 also includes timer 606 (FIG. 6) being triggered by sensor 108 (FIG. 1). The timer 606, in turn, activates switch 106 for a predetermined period of time. In step 1610, switch 106 opens a valve associated with switch 106 or each of the switches in animal repellers 105a-105n (FIG. 1) opens a corresponding valve in that animal repeller. In step 1612, at least an animal repeller is activated and generates motion and/or noise. Step 1612 may include entry of air into pipe 306, to barbed nozzle 315, as a result of the activation of step 1610, and the exiting of air through a flexible tubing 320 (FIG. 3). The escaping air thereby causes the flexible tubing to flail, flap and make noise. In step 1614, the animal leaves the area. Step 1614 may include an animal being startled or aggravated by the motion and/or sound generated in step 1612, and as a result of being startled the animal may leave the perimeter. In step 1616, timer 606 (FIG. 6) ceases the transmission of power to animal repellers 105a-105n based on a pre-configured setting. Step 1616 may include the cessation of electrical power sent by timer 606 based on a measurement of time between the activation of the trigger of timer 606 and a preset unit of time, thereby closing valve 304. Alternatively, step 1616 may include the cessation of power based on a measurement of time between the departure of an animal from the area of repulsion and a preset unit of time.

In an embodiment, each of the steps of method 1600 is a distinct step. In another embodiment, although depicted as distinct steps in FIG. 16, steps 1602-1614 may not be distinct steps. In other embodiments, method 1600 may not have all of the above steps and/or may have other steps in addition to or instead of those listed above. The steps of method 1600 may be performed in another order.

In an embodiment, compressor 102 may be replaced with an air turbine or fan, for example. In an embodiment, instead of using air to cause to the flexible tubing to flail, a motor that triggers an erratic motion of the flexible tubing may be activated by sensor 108. In an embodiment, there may be one switch 106 and one sensor 108 that controls all of animal repellers 105a-105n. In another embodiment, each animal repeller has its own sensor and its own switch. In another in embodiment, each sensor may activate several switches. In an embodiment, there may be one or more sensors and one or more switches. Each sensor may control one or more switches and each switch may control one or more animal repellers.

Each embodiment disclosed herein may be used or otherwise combined with any of the other embodiments disclosed. Any element of any embodiment may be used in any embodiment.

Although the invention has been described with reference to specific embodiments, it will be understood by those skilled in the art that various changes may be made and equivalents may be substituted for elements thereof without departing from the true spirit and scope of the invention. In addition, modifications may be made without departing from the essential teachings of the invention.

1. A system comprising:
a sensor for
sensing a presence of an animal and
generating a signal in response to the sensing; and
a generator of an erratic motion that is activated by the signal from the sensor.

2. The system of claim 1, the generator of the erratic motion including at least a flexible piece of material, the generator causes the flexible material to flail when the generator is activated.

3. The system of claim 1, the generator of the erratic motion including at least a flexible tube, the generator causes the flexible tube to flail when the generator is activated.

4. The system of claim 3, the erratic motion is generated by allowing air to flow through the flexible tube.

5. The system of claim 1, the generator including at least
a flexible tube; and
an electromechanical valve that opens when the signal is received allowing air to flow through the flexible tube causing the flexible tube to flail erratically.

6. The system of claim 1 further comprising one or more lights that flash in response to the sensor detecting the presence of the animal.

7. The system of claim 1, the generator including at least a figurine having a flexible material sticking out of the figurine, the flexible material is caused to flail erratically in response to the sensor sensing the presence of the animal.

8. The system of claim 1, the generator including at least
a float
an artificial lily pad covering the float, and
a flexible material sticking out of a top portion of the artificial lily pad, the flexible material is caused to flail erratically in response to the sensor sensing the presence of the animal.

9. The system of claim 1, further comprising
an air supply and
a control box that controls a duration of time that the generator remains activated after being activated.

10. The system of claim 9, the control box includes at least
a power supply that converts electricity from an available form to a form appropriate for the generator and the sensor,
a timer that determines the duration of time.

11. The system of claim 9, further comprising a hollow artificial rock within which the control box and the air supply are located.

12. The system of claim 1, further comprising
an air supply;
a moisture filter connected to the air supply, air released from the air supply passing through the moisture filter, the moisture filter removing moisture from the air passing through the moisture filter; and
tubing extending from the moisture filter to the generator;
the generator including at least
a T connector connected at one end to the tubing,
an electromechanical valve, one end of the electromechanical valve connected to another end of the T connector,
a pipe, one end of the pipe connected to another end of the electromechanical valve,
a barbed nozzle connected to another end of the pipe,
a flexible tube having one end covering at least a portion of the barbed nozzle,
a stretched sleeve covering at least a portion of the flexible tube that covers the barbed nozzle, and
a band wrapped around the stretched sleeve at a portion that covers the flexible tube at a portion that covers the barbed nozzle.

13. The system of claim 1, further comprising a vehicle, the sensor and the generator being mounted within the vehicle for demonstrating the system.

14. A method comprising:
sensing a presence of an animal; and
in response to the sensing, automatically causing a flexible piece of material to flail in an erratic manner.

15. The method of claim 14, the flexible piece of material being a flexible piece of tubing, the flailing including at least causing air to pass through the flexible piece of tubing.

16. The method of claim 15, the causing of the air to pass including at least opening a valve in response to the sensing therein allowing air to pass into the flexible tube.

17. The method of claim 15, further comprising generating a flow of air from a compressor that causes the air to pass through the flexible tubing;
storing air in an air tank;
determining that a decrease has occurred in number of animals entering an area protected by the sensor; and
in response to the determining, replacing the compressor with the air tank.

18. A method comprising:
providing a sensor for sensing a presence of an animal,
providing a generator that causes a piece of material to flail
connecting the sensor to the generator, such that the sensor sends a signal to the generator in response to the sensor sensing the presence of the animal.
